(19) United States
(12) Patent Application Publication
(10) Pub. No.: US 2017/0167986 A1
(43) Pub. Date: Jun. 15, 2017

(54) Cosmetic Evaluation Box for Used Electronics

(71) Applicant: GDT, Inc., Fremont, CA (US)

(72) Inventors: Tu Nguyen, Fremont, CA (US); Tien Trinh, Ho Chi Minh City (VN)

(21) Appl. No.: 14/690,450

(22) Filed: Apr. 19, 2015

Related U.S. Application Data
(60) Provisional application No. 61/984,666, filed on Apr. 25, 2014.

(51) Int. Cl. G01N 21/95; G01N 21/55; G01N 21/47

(52) U.S. Cl. CPC G01N 21/95; G01N 21/47; G01N 21/55; G01N 2021/555; G01N 2201/126

(57) ABSTRACT

A cosmetic testing fixture is disclosed for evaluating the cosmetic condition of a used electronic device, comprising an enclosure for containing the used electronic device and a fixture that uses the relative amounts of reflected and scattered light off a surface of the used electronic device to determine if there are any cosmetic imperfections such as scratches or cracks on the surface.

### CROSS-REFERENCE TO RELATED APPLICATIONS

The present application takes priority from Provisional App. No. 61/984,666, filed Apr. 25, 2014 which is herein incorporated by reference.

### BACKGROUND

Smartphones and other small electronic devices evolve rapidly, and thus are frequently upgraded by consumers. As a result, many consumers have one or more used electronic devices that they no longer need. Reselling those devices is often a hassle that does not justify the time or the expense of doing so.

In order to determine the value of a used electronic device, its functional capacity and its cosmetic condition need to be evaluated. While evaluating a device's functional capacity usually only requires some simple electronics, evaluating the device's cosmetic condition requires either a human eye (and humans are often biased and inconsistent) or expensive and complex camera systems. In situations where a used electronic device is being repurchased automatically, at a kiosk, for example, the only option being used at present is expensive and complex camera systems. Such camera systems are used to take photographs of the electronic device, and the photographs are then analyzed to determine the number, size, and location of any cosmetic imperfections of the electronic device. This data is then used to determine a cosmetic score for the electronic device and to provide an objective measure of its cosmetic condition.

While it is possible to use a camera system to evaluate an electronic device, it adds a lot of expense and complexity to the evaluation machine. Camera systems are not only expensive, they break and require repair; they require periodic maintenance; and the software needed to operate them is also complex and prone to breaking.

It is typically not necessary to have an image of an electronic device in order to evaluate its cosmetic condition. A simple evaluation of the smoothness of its surface is sufficient to determine whether the device is “like new” or various degrees of “used”. It is desirable to conduct such an evaluation without an expensive camera system.

A need therefore exists for a device that evaluates the cosmetic condition of an electronic device in a cheaper and simpler way than a camera system.

### SUMMARY OF THE INVENTION

An object of the present invention is to reduce the cost and complexity of cosmetic evaluation devices by utilizing a light emitter array and a light sensor array to perform the cosmetic evaluation.

Another object of the present invention is to enable a test of an electronic device's cosmetic condition to be performed easily and cheaply.

For purposes of the present invention, an “electronic device” is a smartphone, tablet, or other small electronic device.

The system of the present invention comprises an enclosure that is large enough to enclose an electronic device and any other of its components, comprising a user interface that enables a user to interact with the device. A device holder is mounted inside the enclosure; the device holder can hold an electronic device without obstructing either the top or bottom surface of the electronic device. At least one light emitter is then used to emit electromagnetic radiation onto at least one surface of the electronic device; at least one reflected light sensor is used to sense the electromagnetic radiation reflected off the surface, and at least one scattered light sensor is used to sense the electromagnetic radiation scattered by the surface. A processor is used to identify the device, to evaluate the amount of electromagnetic radiation sensed by the reflected light sensor or sensors, and to evaluate the amount of electromagnetic radiation sensed by the scattered light sensor or sensors.

In an embodiment, the device holder can be configured in such a way as to turn the device in order to be able to scan both the front and the back sides of the device. In another embodiment, one set of emitters and sensors is used to scan the front of the device and one set is used to scan the back of the device.

In an embodiment, the system comprises a device movement mechanism that moves the device relative to the set of emitters and sensors; in another embodiment, the emitters and sensors are moved with respect to the device.

The emitters and sensors may be arranged in an array, such as a linear array, a two-dimensional array, or a three-dimensional array with some emitters and/or sensors being further away from the surface of the device than other emitters and/or sensors.

In an embodiment, the processor is configured to compare the relative amount of scattered light and reflected light at a first location on the surface of the electronic device with the relative amount of scattered light and reflected light at a second location on the surface of the electronic device.

In an embodiment, the processor is also configured to compare the relative amount of scattered light and relative amount of reflected light from an emitter located at a first distance from the surface of the electronic device to the relative amount of scattered light and relative amount of reflected light from an emitter located at a second distance from the surface of the electronic device.

In an embodiment, some emitters emit electromagnetic radiation of a different frequency, or different intensity, than other emitters.

In an embodiment, the processor is also configured to evaluate the amounts of reflected light and scattered light at multiple locations over the surface of the electronic device, to calculate the standard deviation of at least one of these values, and to use the standard deviation value to estimate the cosmetic condition of the electronic device.

### LIST OF FIGURES

FIG. 1 shows a diagram of the preferred embodiment of the present invention.

FIG. 2 shows the outside of the enclosure of the preferred embodiment of the present invention.

FIG. 3 shows a closeup view of the preferred embodiment of the present invention.

FIG. 4 shows a sample output of the preferred embodiment of the present invention.

### DETAILED DESCRIPTION OF THE PREFERRED EMBODIMENT

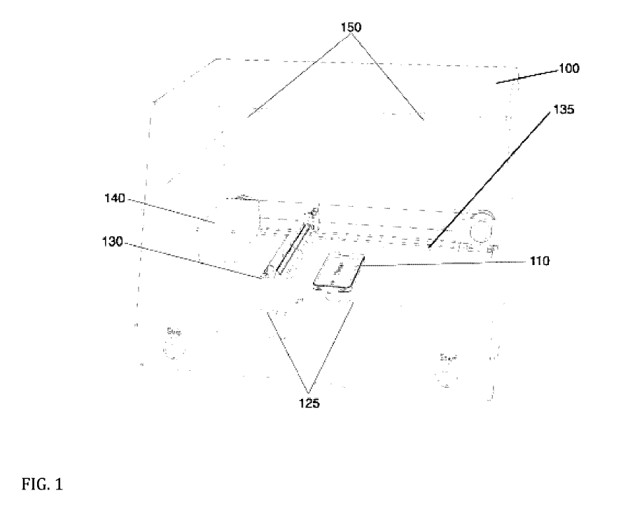

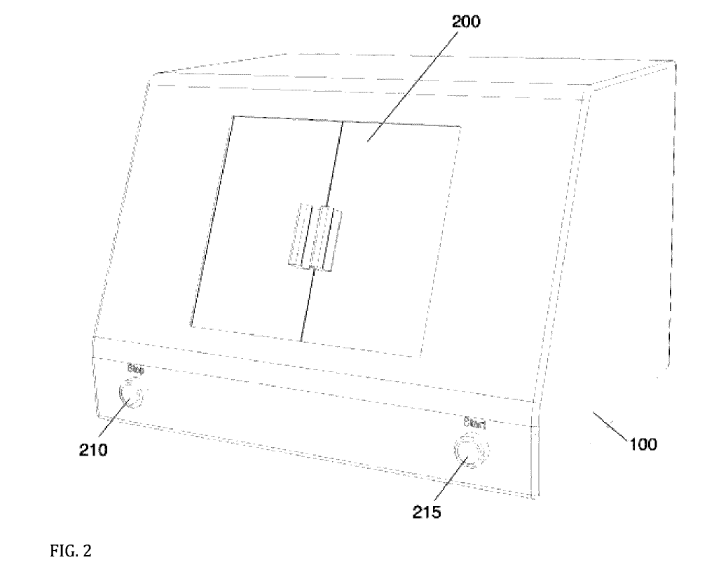

FIG. 1 shows a view of the preferred embodiment of the present invention. It is preferably an enclosure 100, where a used electronic device 110 may be placed. In an embodiment, the exact location of the electronic device 110 is indicated on the floor of the enclosure 100. Connector 125 connects the processor (not shown) to the electronic device. As shown in FIG. 2, doors 200 can be closed during the evaluation, and buttons 210 allow the user to start or stop the evaluation.

A scan bar 130 is mounted on a rail 135. The scan bar can move along the rail in a direction perpendicular to the length of the scan bar. Motor 140 moves the scan bar along the length of the rail. The motor 140 is controlled by the processor.

Light panels 150 are located above the electronic device and the scan bar in such a way as to illuminate the electronic device. In an embodiment, the light panels are not present and the camera is sensitive enough to take good images of the electronic device without light panels.

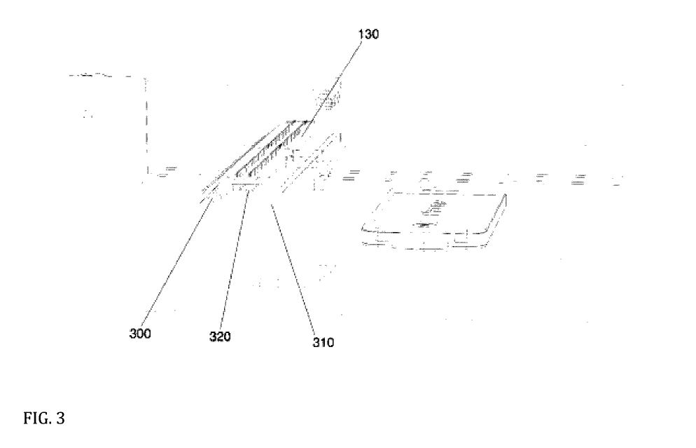

FIG. 3 shows a close-up view of the scan bar 130. A row of infrared LED's 300 are mounted in such a way as to illuminate the surface of the electronic device at an angle, as shown in the Figure. The row is preferably longer than the length of a typical electronic device. A row of reflected light sensors 310 are mounted in such a way as to receive reflected infrared radiation from the surface of the electronic device. A row of scattered light sensors 320 are mounted directly above the electronic device, in such a way as to receive scattered infrared radiation from the surface of the electronic device. While infrared radiation is used in the preferred embodiment, any frequency of electromagnetic radiation may also be used.

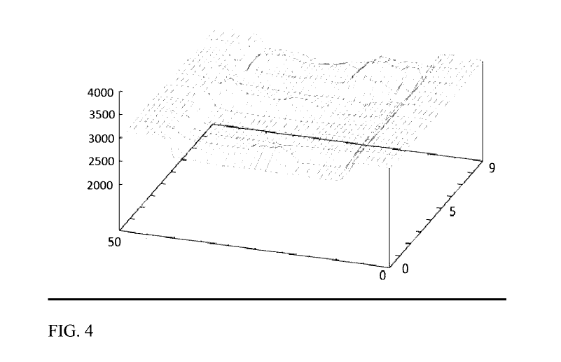

In the preferred embodiment, the scan bar is moved slowly over the surface of the electronic device, with the light emitters continuously on and illuminating the surface of the electronic device, and the reflected and scattered light sensors recording the amount of reflected and scattered light from the surface of the device. The sensors can record their data continuously or at regular or irregular intervals. A three-dimensional surface graph is then made, similar to the graph shown in FIG. 4. The surface graph can record either the outputs of the reflected light sensors or the scattered light sensors. In an embodiment, a user is instructed to flip the device over once the scan is finished and scan the other side of the device.

Once the surface graph is made, the data is evaluated by the processor. In the preferred embodiment, the mean, median, and standard deviation are calculated for the amounts of reflected light and the amounts of scattered light at the data points. If the standard deviation is below a certain low threshold, the device is placed in the “like new” category. If the standard deviation is above a certain high threshold, the device is placed in the “broken” category (with the assumption that extremely high standard deviation values indicate a crack in the screen). If the standard deviation is in between the low threshold and the high threshold, the device is placed in the “used” category. Other categories may also be used in other embodiments.

In an embodiment, the location with extremely high scattered light values is noted by the processor as the site of a possible crack in the screen. The number and extent of locations with extremely high scattered light values is noted by the processor and used in evaluating the cosmetic condition and setting the price for the electronic device.

1. A cosmetic testing fixture for an electronic device, said electronic device comprising a top surface and a bottom surface, said cosmetic testing fixture comprising:
an enclosure, said enclosure comprising a floor on which an electronic device may be placed;
a user interface;
at least one first light emitter, said first light emitter configured to emit electromagnetic radiation onto at least one surface of the electronic device;
at least one first reflected light sensor, said first reflected light sensor configured to sense electromagnetic radiation reflected off the at least one surface of the electronic device;
at least one first scattered light sensor, said first scattered light sensor configured to sense electromagnetic radiation scattered by the at least one surface of the electronic device;
a processor, said processor configured to perform the following functions:
identify the electronic device;
evaluate the amount of electromagnetic radiation sensed by the first reflected light sensor;
evaluate the amount of electromagnetic radiation sensed by the first scattered light sensor.

2. The cosmetic testing fixture of claim 1, further comprising a device holder capable of holding the electronic device without obstructing either its front surface or its back surface, where the at least one first light emitter is configured to emit light onto the front surface of the electronic device and onto the back surface of the electronic device.

3. The cosmetic testing fixture of claim 1, further comprising a device holder capable of holding the electronic device without obstructing either its front surface or its back surface, where the at least one first light emitter is configured to emit light onto the front surface of the electronic device, further comprising:
at least one second light emitter, said second light emitter configured to emit electromagnetic radiation onto the back surface of the electronic device;
at least one second reflected light sensor, said second reflected light sensor configured to sense electromagnetic radiation reflected off the back surface of the electronic device;
at least one second scattered light sensor, said second scattered light sensor configured to sense electromagnetic radiation scattered by the back surface of the electronic device;
wherein the processor is further configured to:
evaluate the amount of electromagnetic radiation sensed by the at least one second reflected light sensor;
evaluate the amount of electromagnetic radiation sensed by the at least one second scattered light sensor.

4. The cosmetic testing fixture of claim 1, further comprising a device holder capable of holding the electronic device without obstructing either its front surface or its back surface, further comprising:
a device movement mechanism that moves the device holder relative to at least one light emitter.

5. The cosmetic testing fixture of claim 1, further comprising a device holder capable of holding the electronic device without obstructing either its front surface or its back surface, further comprising:
a light emitter movement mechanism that moves the at least one first light emitter, the at least one first scattered light sensor, and the at least one reflected light sensor relative to the electronic device.

6. The cosmetic testing fixture of claim 2, further comprising:
a first light emitter movement mechanism that moves the at least one first light emitter, the at least one first scattered light sensor, and the at least one first reflected light sensor relative to the electronic device;
a second light emitter movement mechanism that moves the at least one second light emitter, the at least one second scattered light sensor, and the at least one second reflected light sensor relative to the electronic device.

7. The cosmetic testing fixture of claim 5, comprising:
a plurality of first light emitters arranged in an array;
a plurality of first scattered light sensors arranged in an array;
a plurality of first reflected light sensors arranged in an array;
wherein the first light emitter movement mechanism moves the plurality of first light emitters, the plurality of first scattered light sensors, and the plurality of first reflected light sensors in such a way as to scan the entire surface of the electronic device.

8. The cosmetic testing fixture of claim 7, where the array is a linear array whose length is no smaller than the width of the electronic device.

9. The cosmetic testing fixture of claim 7, where the array is a two-dimensional array.

10. The cosmetic testing fixture of claim 9, where some light emitters are further away from the surface of the electronic device than other light emitters.

11. The cosmetic testing fixture of claim 9, where some light sensors are further away from the surface of the electronic device than other light sensors.

12. The cosmetic testing fixture of claim 4, where the processor is further configured to:
compare the amount of scattered light and the amount of reflected light at a first location on the surface of the electronic device with the amount of scattered light and the amount of reflected light at a second location on the surface of the electronic device.

13. The cosmetic testing fixture of claim 5, where the processor is further configured to:
compare the amount of scattered light and the amount of reflected light at a first location on the surface of the electronic device with the amount of scattered light and the amount of reflected light at a second location on the surface of the electronic device.

14. The cosmetic testing fixture of claim 4, where the processor is further configured to:
compare the amount of scattered light and the amount of reflected light at a first location on the surface of the electronic device with the amount of scattered light and the amount of reflected light at a second location on the surface of the electronic device.

15. The cosmetic testing fixture of claim 7, where the processor is further configured to:
compare the amount of scattered light and the amount of reflected light at a first location on the surface of the electronic device with the amount of scattered light and the amount of reflected light at a second location on the surface of the electronic device.

16. The cosmetic testing fixture of claim 10, where the processor is further configured to:
compare the amount of scattered light and the amount of reflected light from an emitter located at a first distance from the surface of the electronic device with the amount of scattered light and the amount of reflected light from an emitter located at a second distance from the surface of the electronic device.

17. The cosmetic testing fixture of claim 1, where at least one first light emitter emits electromagnetic radiation of a first frequency and at least one other light emitter emits electromagnetic radiation of a second frequency.

18. The cosmetic testing fixture of claim 1, where at least one first light emitter emits electromagnetic radiation of a first intensity and at least one other light emitter emits electromagnetic radiation of a second intensity.

19. The cosmetic testing fixture of claim 1, where the processor is further configured to:
receive data from the at least one scattered light sensor at regular intervals as the at least one scattered light sensor is moved over the surface of the electronic device;
receive data from the at least one reflected light sensor at regular intervals as the at least one reflected light sensor is moved over the surface of the electronic device;
calculate the standard deviation of the measurement values from at least one of the following group: scattered light sensor data, reflected light sensor data;
use the standard deviation to evaluate the cosmetic condition of the electronic device.

20. The cosmetic testing fixture of claim 19, where the processor is further configured to:
locate at least one area on the surface of the electronic device where the scattered light value is significantly higher than in other areas on the electronic device.
